(19) United States
(12) Patent Application Publication
(10) Pub. No.: US 2025/0208570 A1
(43) Pub. Date: Jun. 26, 2025

(54) FRICTION SYSTEM FOR A HOROLOGICAL MOVEMENT

(71) Applicant: Montres Breguet S.A., L'Abbaye (CH)

(72) Inventors: Grégory GAUTHIER, Saint-Cergue (CH); Daniel MATTEAZZI, Le Sentier (CH)

(73) Assignee: Montres Breguet S.A., L'Abbaye (CH)

(21) Appl. No.: 18/921,067

(22) Filed: Oct. 21, 2024

(30) Foreign Application Priority Data
Dec. 22, 2023 (EP) 23220075.8

(51) Int. Cl. G04B 13/02

(52) U.S. Cl. CPC G04B 13/023

(57) ABSTRACT

A friction system for a horological movement includes a staff; a first stationary element mounted on the staff; a second stationary element mounted on the staff; a toothed member mounted to rotate freely on the staff between the first stationary element and the second stationary element; a third stationary element mounted on the staff; a spring mounted on the staff and arranged between the second stationary element and the third stationary element. The spring takes the form of a washer including an inner part close to the staff bearing against the third stationary element, and an outer, peripheral part of the washer bearing resiliently against an annular element of the second stationary element, the spring being resiliently deformed and forming a kinematic link both between the first stationary element and the toothed member, and between the second stationary element and the toothed member up to a predefined friction torque.

### TECHNICAL FIELD OF THE INVENTION

The invention relates to the field of mechanical watchmaking. More particularly, it relates to a friction system for a horological movement.

### TECHNOLOGICAL BACKGROUND

Friction systems are commonly used in horological movements in order to connect a first member to a second member for rotation therewith until a torque limit value is reached. Once this limit value has been exceeded, the two members are no longer connected such that they rotate as one. Typically, this type of system is used for hour and minute display means, in particular at the cannon-pinion for driving display hands or display discs.

The cannon-pinion is typically snapped on by indenting to ensure friction between it and an arbor. Indenting consists of subjecting a tube comprised in the cannon-pinion to pressure opposite a shoulder or clearance of the arbor. This pressure is applied manually, and the result thereof depends on the dexterity and sensitivity of the horologist, and is thus unpredictable, which is unfortunate because the purpose of indenting is to ensure a certain level of friction between the arbor and the cannon-pinion during normal operation of the watch, whereas manual hand-setting operations carried out by the user apply a torque that is greater than that of the friction, which friction torque must therefore not be too high.

Correct adjustment of the friction torque is thus delicate. It is therefore important to precisely control the clamping force applied, and conventional, manual indenting does not achieve this precision, nor the required reproducibility.

Another drawback is that friction obtained via indenting cannot withstand the transmission of high torque and is sensitive to assembly/disassembly.

Other solutions exist for obtaining friction, such as metal foils, but the manufacturing repeatability thereof is difficult to guarantee from one batch to the next.

Helical springs also exist, however these take up too much space.

### SUMMARY OF THE INVENTION

The main purpose of the invention is to overcome the various drawbacks of the prior art.

The invention also aims to provide a friction system that allows for the transmission of a high torque, that is easy to manufacture, and whose friction repeatability is easy to manage.

To this end, the present invention relates to a friction system for a horological movement comprising:
a staff intended to be mounted in the horological movement;
a first stationary element mounted on the staff;
a second stationary element mounted on the staff;
a toothed member mounted to rotate freely on the staff between the first stationary element and the second stationary element;
a third stationary element mounted on the staff;
a spring mounted on the staff and arranged between the second stationary element and the third stationary element.

According to the invention, the spring takes the form of a washer comprising an inner part close to the staff bearing against the third stationary element, and an outer, peripheral part of the washer bearing resiliently against an annular element of the second stationary element, the spring being resiliently deformed and forming a kinematic link both between the first stationary element and the toothed member, and between the second stationary element and the toothed member up to a predefined friction torque.

According to other advantageous alternative embodiments of the invention:
the washer comprises at least two catches disposed at its outer periphery, the catches being arranged to resiliently bear against the annular element of the second stationary element;
the first stationary element and the toothed member each have a conical contact surface;
the staff comprises a shoulder intended to cooperate with a flat section of the second stationary element;
the third stationary element takes the form of a ring, the ring having an excessive thickness in the vicinity of the hole through which it is mounted on the staff, the excessive thickness being arranged so as to bear against the spring;
the second stationary element has a conical contact surface with the catches of the spring;
the catches on the outer periphery of the spring and the inner part lie in two different planes.

The invention further relates to a horological movement comprising a friction system according to the invention.

### BRIEF DESCRIPTION OF THE FIGURES

Other features and advantages of the invention will become apparent from the following detailed description, which is given by way of example and is by no means limiting, with reference to the accompanying drawings in which:

FIG. 1 shows a perspective view of a friction system according to the invention;

FIG. 2 shows an exploded view of a friction system according to the invention;

FIG. 3 shows a cross-sectional view along the axis A-A of a friction system according to the invention.

### DETAILED DESCRIPTION OF THE INVENTION

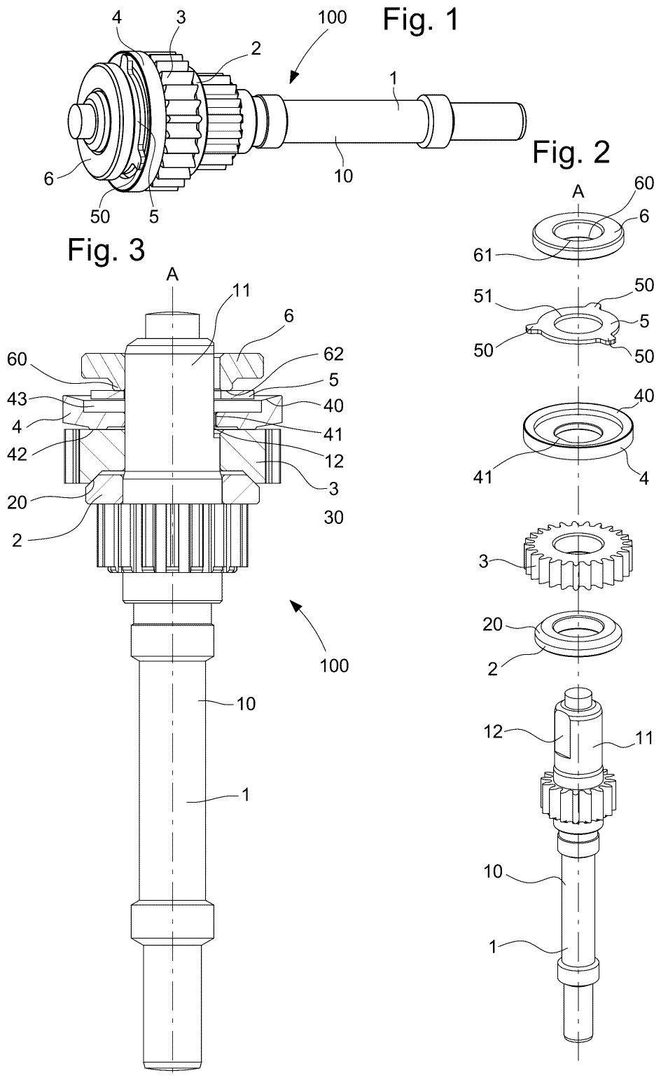

FIG. 1 shows a friction system 100 according to the invention. This system comprises a staff 1 arranged to be mounted in a horological movement, which staff can comprise parts with sections 10, 11 of different diameters.

The staff 1 carries a toothed member 3, in this case a pinion, mounted so as to rotate freely on the staff 1. Alternatively, this toothed member 3 can be a wheel. The staff 1 can also carry a plurality of toothed members, and can take a large number of known shapes depending on the needs of the person skilled in the art.

As illustrated in FIG. 2, the system comprises a first stationary element 2, such as a flange, driven onto and extending perpendicularly to the staff 1. This flange 2 has a first conical bearing surface 20 and acts as a first friction surface between the toothed member 3 and the flange 2.

The system 100 further comprises a second stationary element 4, the toothed element being positioned and rotating about the staff 1, between the first stationary element 2 and the second stationary element 4. The second stationary element 4 takes the form of a collar comprising a rib 42 of annular shape on its face oriented towards the toothed element 3, forming an annular bearing surface between the toothed element 3 and the second stationary element 4.

On its other face, the collar 4 has an annular peripheral rim 40 forming a skirt, an empty space 43 thus extending between the annular peripheral rim 40 and the centre of the collar 4. As can be seen in FIG. 3, the annular peripheral rim 40 is bevelled to form a conical bearing surface.

Advantageously, the staff 1 comprises a shoulder 12 arranged to cooperate with a flat section 41 of the second stationary element 4. This arrangement makes it possible to slide the second stationary element 41 onto the staff while ensuring that it is correctly positioned and held on the staff once mounted.

The system further comprises a third stationary element 6 which is mounted or driven onto the staff 1. This third stationary element takes the form of a ring 6, the ring 6 having an excessive thickness 60 in the vicinity of the hole 61 through which it is mounted on the staff 1. The excessive thickness 60 has a diameter that is smaller than that of the ring 6 and forms an annular bearing surface 62 for a spring 5.

The spring 5 is mounted such that it can move or not move about the staff 1 and is arranged between the second stationary element and the third stationary element.

The spring 5 takes the form of a flat washer comprising an inner part 51 in the immediate vicinity of the staff 1 which bears against the third stationary element 6, and more precisely against the excessive thickness 6, and an outer peripheral part which resiliently bears against the conical surface 40 of the skirt 4.

At rest, the spring 5 takes the form of a flat washer, which then resiliently deforms when stressed between the second stationary element 4 and the third stationary element 5. The use of a flat washer is particularly advantageous because the use of a flat part makes it easier to reproduce, particularly compared with a domed element, for example.

According to one embodiment of the invention, the spring 5 comprises at least two catches 50 arranged at the outer periphery of the washer and are intended to resiliently bear against the conical bearing surface 40 of the second stationary element 4. Thus, when all of the parts are mounted, the spring 5 allows a kinematic link to be formed both between the first stationary element 2 and the toothed member 3, and between the second stationary element 4 and the toothed member 3 up to a predefined friction torque.

Preferably, and as illustrated in the figures, the spring 5 has three catches for an improved distribution of forces and to facilitate deformation of the spring.

The catches 50 are distributed on the washer 5 at identical angular distances for a good distribution of the bearing force on the annular peripheral rim 40 of the collar 4. In the example shown, the three catches are arranged at 120° to each other. If the number of catches is greater, for example in the case of five catches, they would be arranged at 72° to each other.

According to a particularly advantageous aspect, the friction torque can be perfectly adjusted by precisely driving the ring 6 onto the staff 1 against the spring 5, the resilient force exerted by the spring 5 on the stationary element 4 making it possible to obtain a very precise friction torque.

When the system is assembled, as shown in FIG. 3, the catches 50 on the outer periphery of the spring 5 and the inner part 51 are located in two different planes, with the assembly flexing the spring 5 to stress it between the ring 6 and the collar 4.

The stress of the spring 5 can thus be modified by acting on the distance between the planes of the bearing surfaces 62 and 40, by moving the ring 6 on the staff 1, and as a result the friction torque that the system can withstand before the toothed member 3 pivots relative to the staff 1. Such an arrangement makes adjustment extremely simple and easy to reproduce.

The invention further relates to a horological movement comprising a friction system according to the invention.

The invention further relates to a method for assembling a friction system according to the invention, the method comprising the following steps of:
providing a staff 1;
driving a first stationary element 2 onto the staff 1 into a predetermined position;
sliding a toothed member 3 onto the staff 1 as far as the first stationary element 2;
sliding the second stationary element 4 onto the staff 1, while orienting the second stationary element 4 relative to the staff by means of a flat section 41 cooperating with a shoulder 12 formed on the staff 1;
placing a spring 5 equipped with at least three catches 50 arranged at the outer periphery of the spring 5, the catches 50 bearing against the second stationary element 4;
gradually driving a third stationary element 6 onto the staff 1, so as to compress the spring 5 between the second stationary element 4 and the third stationary element 6, in order to obtain a kinematic link both between the first element and the toothed member, and between the second stationary element and the toothed member until a predefined friction torque is obtained.

It goes without saying that the present invention is not limited to the example shown and that various alternatives and modifications that may be apparent to a person skilled in the art can be made thereto, while still remaining within the scope of the invention as defined by the claims.

1. A friction system for a horological movement, which friction system comprises:
a staff configured to be mounted in the horological movement;
a first stationary element mounted on the staff;
a second stationary element mounted on the staff;
a toothed member mounted to rotate freely on the staff between the first stationary element and the second stationary element;
a third stationary element mounted on the staff;
a spring mounted on the staff and arranged between the second stationary element and the third stationary element;
the spring taking the form of a flat washer comprising an inner part close to the staff bearing against the third stationary element, and an outer, peripheral part of the washer bearing resiliently against an annular element of the second stationary element, the spring being arranged to be stressed in order to resiliently deform between the second stationary element and the third stationary element, and to form a kinematic link both between the first stationary element and the toothed member, and between the second stationary element and the toothed member up to a predefined friction torque.

2. The system according to claim 1, wherein the washer comprises at least two catches disposed at its outer periphery, the catches being arranged to resiliently bear against the annular element of the second stationary element.

3. The system according to claim 1, wherein the first stationary element and the toothed member each have a conical contact surface.

4. The system according to claim 1, wherein the staff comprises a shoulder arranged to cooperate with a flat section of the second stationary element.

5. The system according to claim 1, wherein the third stationary element takes the form of a ring, the ring having an excessive thickness in the vicinity of the hole through which the ring is mounted on the staff, the excessive thickness being arranged so as to bear against the spring.

6. The system according to claim 1, wherein the second stationary element has a conical contact surface with the catches of the spring.

7. The system according to claim 1, wherein the catches on the outer periphery of the spring and the inner part lie in two different planes.

8. A method for assembling a friction system according to the invention, the method comprising the following steps of:
providing a staff;
driving a first stationary element onto the staff into a predetermined position;
sliding a toothed member onto the staff as far as the first stationary element;
sliding a second stationary element onto the staff, while orienting the second stationary element relative to the staff with a flat section cooperating with a shoulder formed on the staff;
placing a spring on the staff;
gradually driving a third stationary element onto the staff, so as to compress the spring between the second stationary element and the third stationary element, in order to obtain a kinematic link both between the first element and the toothed member, and between the second stationary element and the toothed member until a predefined friction torque is obtained.
